(19) United States
(12) Patent Application Publication
(10) Pub. No.: US 2013/0206616 A1
(43) Pub. Date: Aug. 15, 2013

(54) CLEANROOM BOX

(71) Applicants: Phillip John Allen, Lincolnshire (GB); Paul Henry Fairfield, Kings Bromley (GB)

(72) Inventors: Phillip John Allen, Lincolnshire (GB); Paul Henry Fairfield, Kings Bromley (GB)

(21) Appl. No.: 13/766,036

(22) Filed: Feb. 13, 2013

Related U.S. Application Data
(60) Provisional application No. 61/598,148, filed on Feb. 13, 2012.

(51) Int. Cl. B65D 19/18; B65D 19/38; B29D 22/00; B65D 19/40

(52) U.S. Cl. CPC B65D 19/18; B65D 19/40; B65D 19/38; B29D 22/003
USPC 206/223; 206/598; 206/386; 206/599; 29/428; 156/253; 156/154

(57) ABSTRACT

A cleanroom box made from a substantially inflexible material, to be used for the storage of fluids within a clean room; the box comprising easy clean surfaces, an internal access point leading to a specially designed space for the deposit of tubing, and fitted with a forkliftable pallet base for easy mobility within a workroom.

### BACKGROUND OF THE INVENTION

The present application is related to storage containers, and more particularly, storage containers for the storage of fluids within a cleanroom. The storage container comprises easy clean surfaces, an internal access point for the storage of pipework and hoses, and a forkliftable bottom pallet.

Boxes and storage containers for use in a cleanroom have previously been constructed of stainless steel, plastic, and other materials. However, the stainless steel and some plastic designs can be difficult to clean making sterilization of the containers difficult, if not impossible. Furthermore, these containers are often heavy, making movement of the containers difficult within the cleanroom environment.

Many containers used in cleanroom environments, being made of stainless steel, are also expensive to manufacture and are relatively inflexible with regard to modifications of the stainless steel product. The invention disclosed here is adaptable to modifications of particular customers and is easy to be sterilized.

### SUMMARY OF THE INVENTION

Objects of the invention, e.g. it is an object of the present invention to provide a new and improved cleanroom box which is easy to sterilize, easy to modify, easy to move within the cleanroom, provides easy access to pipework, and provides easy storage and transportation of fluids within a cleanroom environment.

In accordance with the invention, these and other objects are attained by providing a cleanroom box comprising a donor box comprising four sides and a base, where there is at least one hole in the base of the box; the cleanroom box further comprising at least one pallet base attached to the base of the donor box and where the donor box and the pallet base provide for two openings, the first directly below the donor box, and the second opening below the top of the pallet base, and where the cleanroom box can be sterilized.

According to another aspect of the invention, a cleanroom box capable of storing sterile liquids is provided which comprises a donor box comprising four sides, a base, and a hole in the base, an upper and lower pallet base, each of which have four sides a top and a bottom, a first easy clean plate of substantially the same length and width as the upper and lower pallet bases being attached to the bottom of the donor box, and a second easy clean plate being attached between the upper and lower pallet boxes, and where the donor box is connected to the combined upper and lower pallet base, and where all products are capable of being sterilized.

According to another aspect of the invention, a cleanroom box for sterile liquids is provided comprising a donor box with four sides, a base, at least four legs, and open top, and at least one hole in the base of the box, a pallet base of substantially the same length and width as the donor box comprising four sides, a flat top, a base, and support legs below the base, an easy clean plate secured to the top of the pallet base, and wherein the donor box includes legs secured to the top of the pallet base, the seams being secured by plastic welding, and wherein said box being capable of being sterilized.

According to still another aspect of the invention, a method of manufacturing a cleanroom box comprises the steps of securing a donor box to an easy clean plate, securing said donor box and easy clean plate to an upper pallet base, welding the seams with plastic to secure the donor box, easy clean plate, and pallet base, cutting a hole in the donor box base, and securing a pipe within the hole cut in the donor box base.

### BRIEF DESCRIPTION OF THE DRAWINGS

A more complete appreciation of the present invention and many of the attendant advantages thereof will be more fully understood by reference and to the following descriptions in connection with the accompanying drawings

FIG. 1 is a perspective view of a cleanroom box in accordance with the present invention.

FIG. 2 is a perspective view of a cleanroom box with one removable side shown in an open position in accordance with the present invention.

FIG. 3 is a perspective view of a cleanroom box as situated on a dolly in accordance with the present invention.

FIGS. 4A, 4B, 4C, and 4D are perspective views of parts of a clean room box both attached and separated in accordance with the present invention.

FIG. 5 is a perspective view of parts of a cleanroom box oriented so that one can identify how the parts are combined to create the cleanroom box in accordance with the present invention.

FIGS. 6A, 6B, 6C, and 6D are perspective views of parts of a cleanroom box separated so that the individual parts can be identified in accordance with the present invention.

FIGS. 7A, 7B, 7C, and 7D are perspective views of alternative parts for the construction of a cleanroom box in accordance with the present invention.

FIGS. 8A, 8B, and 8C are perspective views of a lower pallet base for one variation of a cleanroom box in accordance with the present invention.

FIGS. 9A and 9B are perspective views of an upper pallet base for one variation of a cleanroom box in accordance with the present invention.

FIGS. 10A, 10B, and 10C are perspective views of a lower pallet base for one variation of a clean room box in accordance with the present invention.

FIG. 11 is a perspective view of a section of the cleanroom box in accordance with the present invention.

FIG. 12 is a perspective view of a view of a cleanroom box in accordance with the present invention.

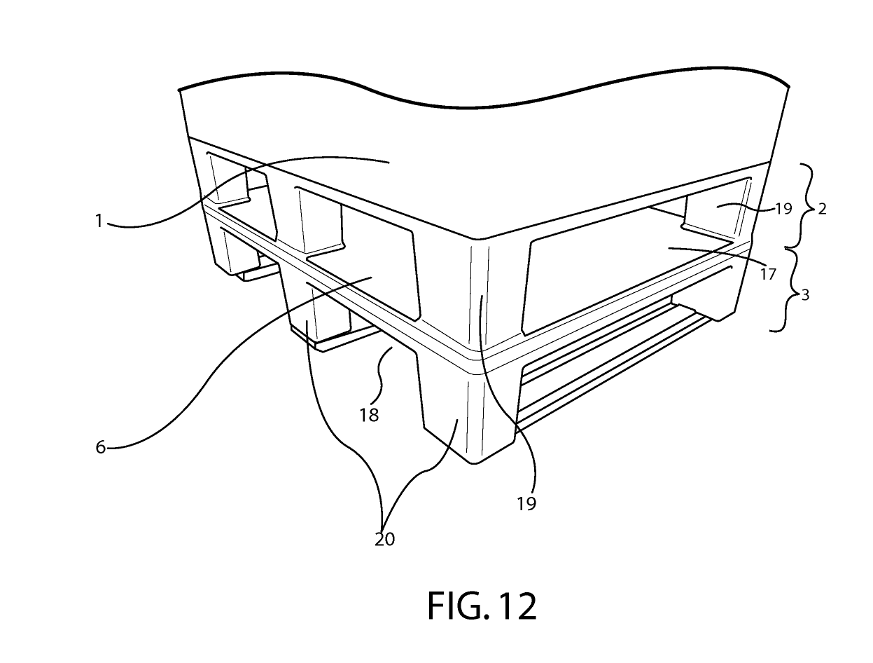

FIG. 13 is a perspective view of a view of the tubing or pipework opening in the cleanroom box in accordance with the present invention.

FIG. 14 is a perspective view of a view of a cleanroom box in accordance with the present invention.

### DETAILED DESCRIPTION OF THE INVENTION

The embodiments of the invention and the various features and advantages thereto are more fully explained with references to the non-limiting embodiments and examples that are described and illustrated in the accompanying drawings and set forth in the following descriptions of those drawings. The figures in the accompanying drawings are not necessarily drawn to scale and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims.

As used herein, terms such as “a,” “an,” and “the” include singular and plural referents unless the context clearly demands otherwise.

The term “cleanroom” refers to a location within a facility in which biopharmaceutical liquids are either produced or used under sterile conditions. Various levels of cleanliness may be achieved, and the cleanroom denotes a stringent sterility requirement as used in the production and handling of biopharmaceutical products. Typically, the requirements are based on FDA sterilization requirements or typical Grade A, B, C, or D air classification systems for manufacture of sterile products, having a maximum number of particles or micro-organisms per m³.

The term “easy clean surface” as used herein is to mean a surface that is low porous or non-porous, relatively smooth to the touch, has plastic welded seams, contains few, if any, sharp (e.g. 90 degree) corners, and is capable of being sterilized for use in a cleanroom. Further, an easy clean surface should be free of spaces where foreign materials or moisture could be easily trapped. Such easy clean surfaces are present on all external surfaces, i.e. those open to the air. The easy clean surface, by having smooth surfaces and no seams or areas to trap moisture and other materials, can be thoroughly and easily cleaned for use in a cleanroom environment. The materials for these easy clean surfaces include plastic or plastic polymer materials, carbon fiber and metallic materials. The surface of these materials, which are open to the air, are non-porous, smooth to the touch and can be cleaned or sterilized without breaking down.

The term “donor box” as used herein is a box that is capable of being attached to a donor pallet and which can incorporate removable sides and provides an area for the storage of sterile materials. Such donor box will typically be made of a plastic or plastic polymer material, but may incorporate or be wholly made of other materials, so as to increase strength and rigidity. Such materials may include other plastic materials, carbon fibers, metals, and other suitable materials known to one of skill in the art. The donor box may further comprise supporting structures within the walls and floor of the box. The support structures may comprise vertical and horizontal support ribs and cross ribs within the walls and floor so as to provide rigidity and strength. Walls may contain no, a few, or numerous support structures, or may include a honeycomb like structure throughout the wall or floor section so as to provide additional strength or rigidity where necessary.

The term “pallet base” as used herein means a pallet capable of supporting a product placed on, or attached to the pallet base, and is configured to accept the fork of a forklift for the movement and transportation of goods attached to or sitting on the pallet. The pallet is typically made of a plastic or plastic polymer material, such as a high density polyethylene, but may also comprise carbon fiber, metal, and other materials known in the art. The pallet base is one of any number of various pallet designs and may include any number of support legs and or cross supports between the legs. Typical pallet bases to be used include hygiene pallets, a class of pallets that comprise few, if any, cracks or crevices that harbor bacteria and prevent sterilization.

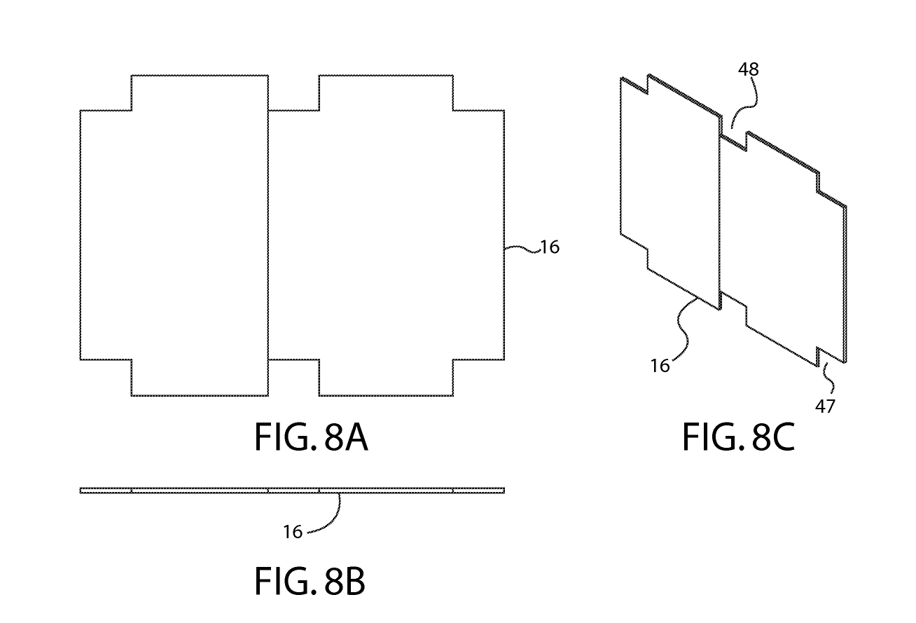

The term “easy clean plate” means a plastic, plastic polymer, carbon fiber, or metal plate where at least one side of the easy clean plate has an easy clean surface, such that the easy clean plate can be attached to a structure allowing the structure to be easily sterilized. Essentially, the easy clean plate becomes a façade on the surface of another structure, and allows the structure to remain in place, but have a new façade that is easily cleanable for entry into a cleanroom. Examples of easy clean plates are shown in FIGS. 8-10.

The term “plastic welding” as used herein means any process of joining two or more plastic materials together, often through the use of a plastic filler. Plastic welding is commonly utilized to fill a seam or corner, or bonding the plastic together to form a seal between two or more pieces of plastic. Such welding techniques include but are not limited to hot gas welding, speed tip welding, extrusion welding, solvent welding and other forms of plastic welding techniques known in the art. The appropriate plastic to use, filler materials, and method for welding will be obvious to one of ordinary skill in the art.

The terms “about” and “substantially” are interchangeable and mean within 10% of a stated length. For example, a length of about 1000 mm includes lengths of 900 mm to lengths of 1100 mm and all lengths in between.

The terms “tubing” or “pipework” are used interchangeably, and refer to flexible or inflexible tubing that allow for fluids to flow through said tubing.

Cleanroom environments allow materials to be combined, such as chemical precursors and biological materials, such that the cleanroom prevents the introduction of foreign material. Cleanroom environments have strict controls to prevent the introduction of foreign materials that could damage or destroy the sterile materials within that cleanroom. Storage containers for use in such environments therefore themselves need to be able to be sufficiently sterilized that they can be introduced into the cleanroom. Small containers are easy to sterilize as they likely do not need to carry substantial weight and so can be lightweight and made of easily cleaned materials. Large containers for the storage and transportation of 250 L to 1000 L or more of fluids require the use of heavier materials and materials with substantial support built into the materials to handle the additional weight. These large containers are difficult to completely sterilize and absent such sterilization, they cannot enter the cleanroom environment.

Such mechanisms to sterilize include any number of known methods, including increased temperature, pressure, steam, UV or other light inactivation, or use of solvents, detergents and other materials to clean and/or disinfect the clean room box. Autoclaving or other similar process is one such mechanism, that can be used alone or in conjunction with other processes to ensure that sufficient cleanliness is met.

Suitable sterility conditions depend on the particular clean room environment, but are intended to meet FDA Sterility Assurance Level of <10⁻⁶ or about <10⁻³ or about, 10⁻² or other appropriate measurement. Other appropriate measurements utilize maximum number of particle permitted per m³ with a size of 0.5-5 μm from 3,500,000, about 350,000, about 3,500, and less than 3,500, and having particles of >5 μm less than 20,000, less than 2,000, and less than 5, and 1 or fewer. Similarly, a measure of maximum number of viable micro-organisms per m³ may be utilized, where in a room or surface has less than 500, less than 100, less than 5 and less than 1 viable micro-organisms per m³.

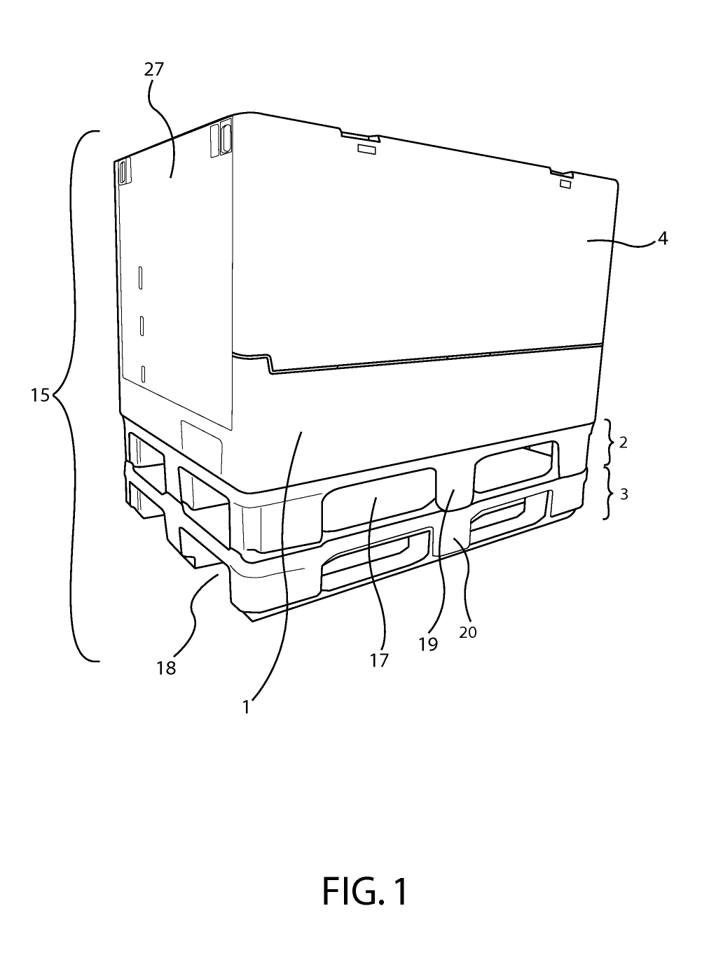

Referring to FIGS. 1, 2, and 3, a clean room box 15 in accordance with the invention is illustrated and comprises a box for the storage and transportation of sterile materials in a cleanroom. Typically, materials to be transported include liquid materials that require sterile conditions, including but not limited to materials for use in the manufacturing of drugs, biological products, or other products requiring sterility, or the storage and transfer of biological materials.

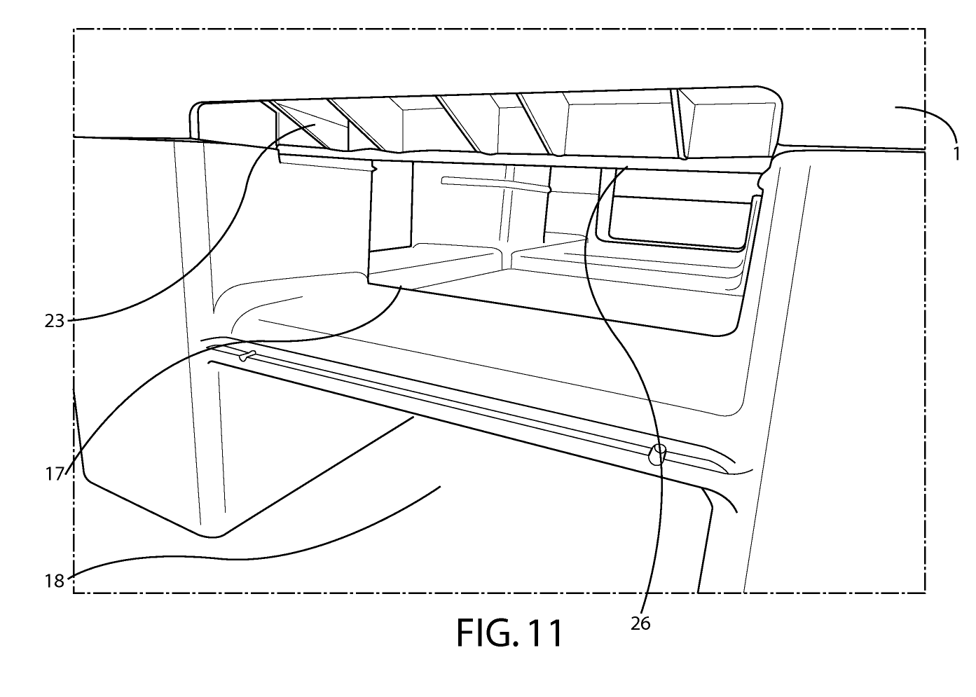

The cleanroom box 15 is made from a substantially inflexible material, such as any number of plastic or plastic polymers known to one of ordinary skill in the art, carbon fiber, and metal materials. The cleanroom box 15 additionally comprises supporting structures within the walls and bases of the donor box 1, and pallet bases in the various embodiments. Thus, the walls and bases of the donor box 1, and the pallet bases are substantially hollow, or contain rib supports. The use of ribs or cross ribs within the structure of the walls allows there to be substantial strength and rigidity without significant additional weight. An example of a supporting rib 23 can be seen in FIG. 11. However, it is understood that not all donor box 1 or pallet bases need to be hollow or contain supports.

It is understood that the cleanroom box 15 may be made of different materials and that the cleanroom box 15 may comprise numerous parts, each made of different materials.

Some materials have porous surfaces or sharp corners, and are therefore typically not suitable for use on exterior surfaces of the invention. Non-porous, smooth materials are suitable for exterior surfaces in the invention. However, even such non-porous materials may provide space for collecting dust or harboring moisture or bacteria. Plastic welding joints, small gaps, cracks, and covering open spaces eliminate areas prone to harboring undesirable material. Accordingly, the purpose of the easy clean surface is that the surface is smooth, non-porous, and allows for quick and easy sterilization.

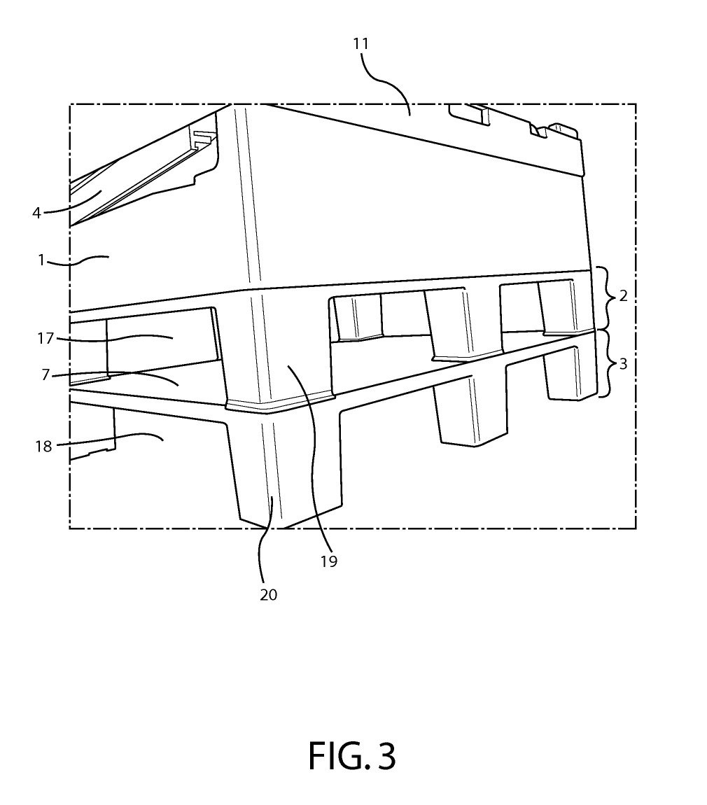

As shown in FIG. 1, a cleanroom box 15 according to the invention comprises a donor box 1. The donor box 1 is configured to accept a storage bag for the storage of sterile fluids. The donor box 1 comprises four donor box sides 27 and a donor box bottom 26. Removable box sides 4 are designed to attach to each of the four donor box sides 27 and are configured to accept a top, thus providing a six sided container. FIG. 3 also shows the use of the removable box sides 4 and cleanroom box top 11. The use of the removable box sides 4 and cleanroom box top encloses materials within the cleanroom box 15, and also allows additional cleanroom boxes 15, to be stored on top of each other.

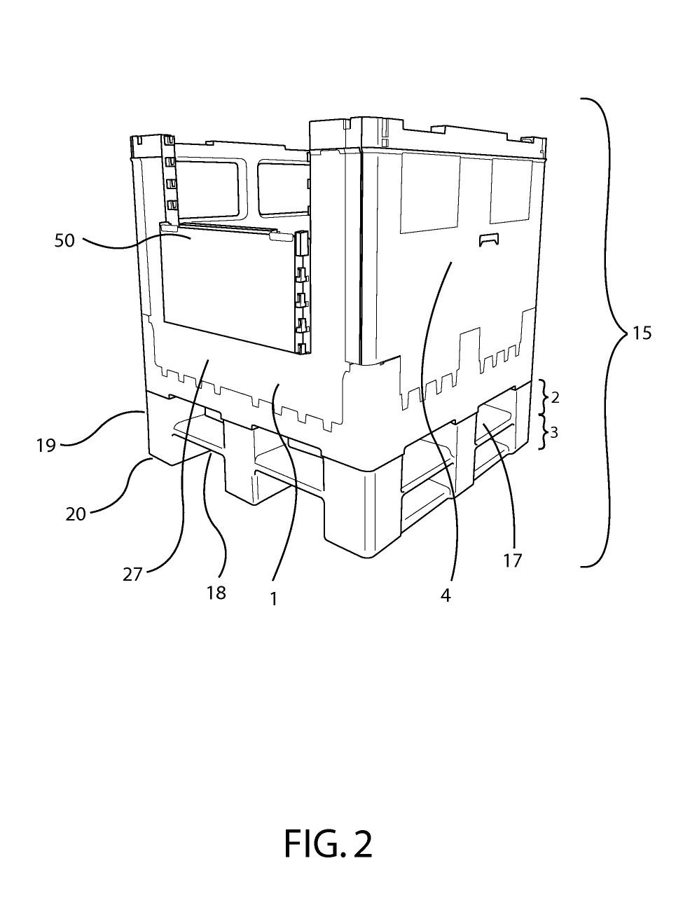

FIG. 2 shows a cleanroom box 15 according to the invention where one removable box side 4, is shown in an open position. When configured, there are four removable box sides 4, one for each donor box side 27. The removable box sides may comprise a single piece, or comprise a plurality of parts. Like the donor box 1, the removable box sides 4 are made from the same or similar substantially inflexible material, such as a plastic or plastic polymer, carbon fiber, or metal, or combinations thereof. The removable box sides 4 may comprise a hinged mechanism, such as shown in FIG. 2, which allows a side of the removable box side 4, to be opened. Alternatively, the removable box sides 4 may comprise multiple pieces that can be removed without removing the entire box side 4. Such pieces may interlock or be secured with other fastening means to one another.

FIG. 2 shows one embodiment of a cleanroom box 15 according to the invention that also comprises an upper pallet base 2. The upper pallet base 2 is affixed below the donor box 1, and is situated so as to create a pipework opening 17 for the storage of pipework. This pipework is intended to be attached to a storage bag or other storage container, and the pipework facilitates the transfer of the sterile liquids between containers. FIG. 2 also shows a lower pallet base 3. The lower pallet base 3 is affixed below the upper pallet base 2. The lower pallet base 3 is configured to provide a forklift opening 18.

The pallet bases may be any size pallet base that includes an opening for use with a forklift. The pallet base may be as small as 600 mm on a length or width. There is no current maximum length for a pallet base, so long as it comprises an opening for use with a forklift. Typical sizes used in manufacturing the materials include pallets that are about 600 mm by about 600 mm, about 800 mm by about 800 mm, about 1000 mm by about 1000 mm, about 1100 mm by about 1100 mm, and about 1200 mm by about 1200 mm. Pallet sizes may also be rectangular in shape, and be about 600 mm by about 800 mm, about 600 mm by about 1000 mm, about 600 mm by about 1200 mm, about 800 mm by about 1000 mm, about 800 mm by about 1200 mm, and about 1000 mm by about 1200 mm, or any lengths in between.

FIG. 1 illustrates one embodiment which comprises an upper pallet base 2 and a lower pallet base 3 each comprising nine support posts. Like other features of the invention, the pallet structure comprises internal support structures, such as horizontal and vertical supports or honeycomb like structures, but it is understood that the pallet structure may omit support structures or be made of a solid material. These support structures are enclosed within the pallet, but may also be open to the air. Where the support structures are open to the air, they will be further enclosed to eliminate the open structure. Accordingly, numerous pallet bases are suitable for use in the invention, so long as the pallet base is capable of supporting a load placed on it and comprises a forklift able opening. Examples of suitable pallets include those described in U.S. Pat. Nos. 6,216,608, 5,778,801, and 6,125,770, which are incorporated by reference in their entirety.

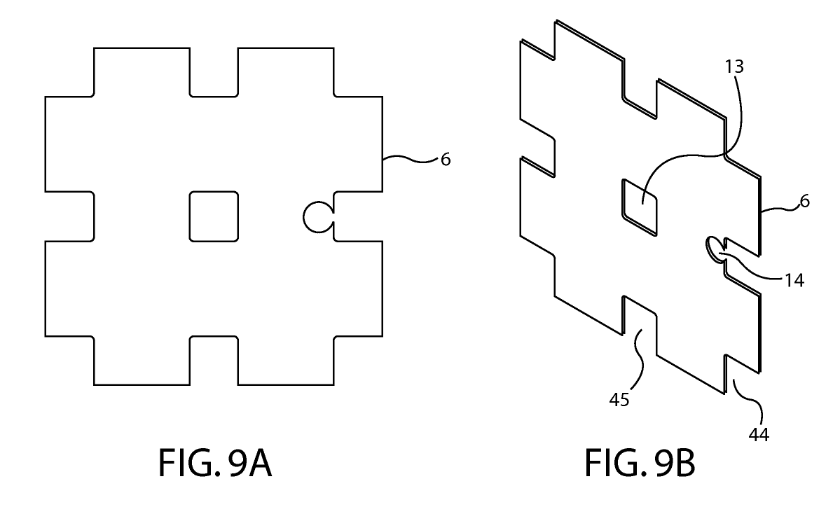

The upper pallet base 2 and lower pallet base 3 comprises 6 support posts, but it is understood that any number of supporting posts may make up the invention. Accordingly, the invention is not confined to a pallet base that comprises four, six, or nine support posts, which are typical. Any number of support posts may be utilized, so long as the pallet can support a load placed upon it and has a forkliftable opening. The upper pallet base 2 comprises upper supports 19. The lower pallet base 3 comprises lower supports 20. Additional upper and lower supports 19 and 20 both located on the outside edge of the pallet base and also in the center of the pallet base are acceptable. A pallet base comprises four corner posts, but other configurations without corner posts are also acceptable. The upper and lower pallet bases may comprise four corner posts and additional support posts. Support posts within the center of the pallet bases 2 and 3 are also acceptable. For example, configuration of nine support posts, (three rows of three posts) is one typical scheme that can be used. This allows for there to be eight support posts on the outside edge of the pallet bases and a single support post in the middle of the pallet bases. The nine spaces for these support posts can be seen in FIG. 9, and identifies the shelf leg hole 13, where the center post would exist, and the corner leg holes 44 and edge leg holes 45, where the additional eight support posts would fit. The necessary support posts and corresponding easy clean plates to be used with such support posts will be obvious to one of skill in the art.

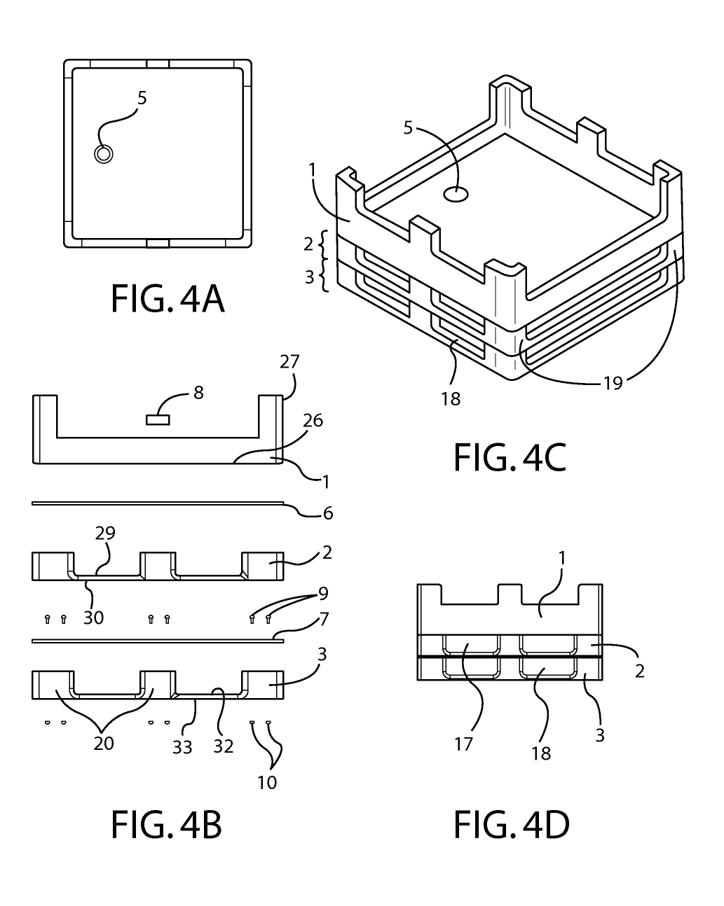

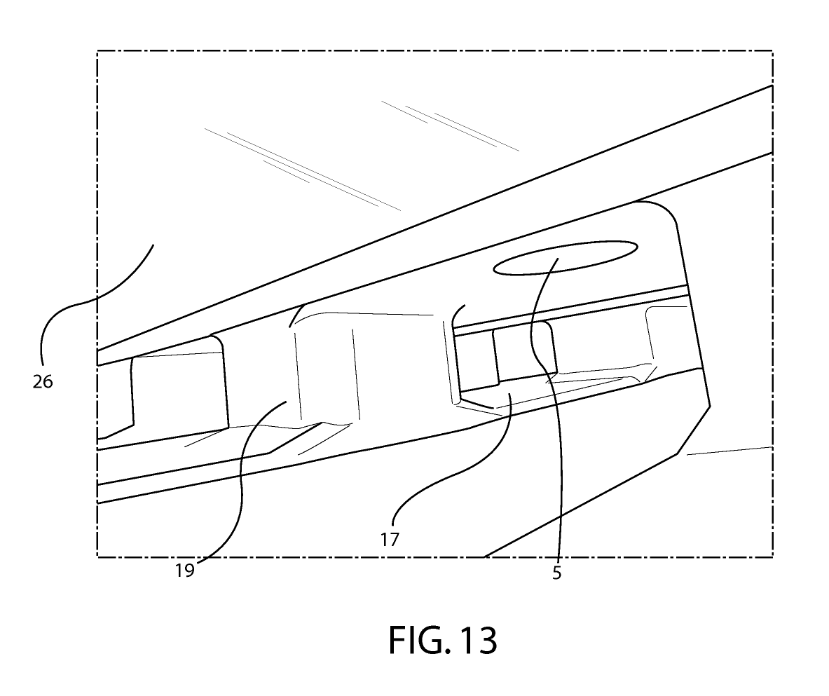

FIGS. 4, 6, 11, and 13, among others, illustrate the position of a donor box bottom plate 6. The donor box bottom plate 6 is a sheet of material that can be welded to both the donor box bottom 26 and to the top of the upper pallet base 2, so as to seal off any spaces that would otherwise be open to the air. By welding the donor box bottom plate 6 to the donor box bottom 26, the support ribs 23 on the donor box bottom 26, can effectively be sealed off. The donor box bottom plate 6 serves as the new bottom of the donor box 1, as can be seen in FIG. 13. This surface is an easy clean surface and facilitates the sterilization of the cleanroom box 15.

The donor box bottom plate 6 is one example of an easy clean plate that is secured to a feature on the invention that requires sealing off of spaces that may prevent sterilization. Examples of this easy clean plate are shown in FIGS. 8-10, but are not limited to the designs in FIGS. 8-10.

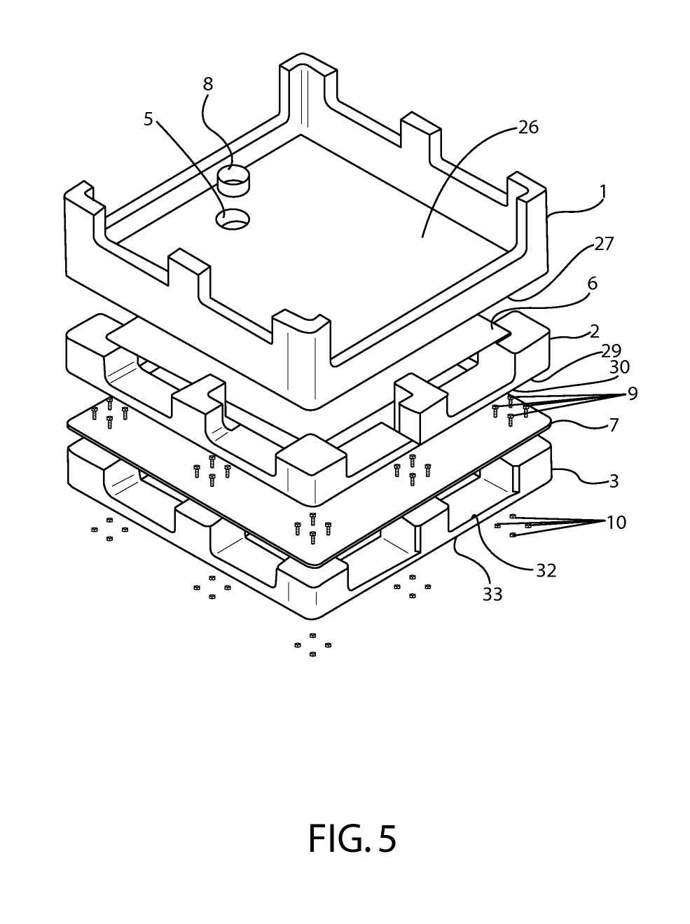

FIGS. 4 and 5 show more detail of the individual parts of a cleanroom box 15. FIG. 4 shows the donor box 1 comprising a donor box hole 5, situated in the bottom of the donor box 1. This donor box hole 5 allows tubing and other pipework to be run through the donor box bottom 26, and into the pipework opening 17. The donor box hole 5 can be placed anywhere in the donor box bottom 26 based on the particular pipework and tubing to be used. There can be one or more than one donor box hole 5 in the donor box bottom 26. Multiple donor box holes 5 allow for different tubes and pipework running through different holes.

The donor box hole 5 is typically from 20-200 mm in diameter, but can range from 1 mm to 500 mm. The donor box hole 5 can be from about 10-250 mm, or about 25-200 mm, or about 30-150 mm or about 50-150 mm, or about 60-130, or about 75-125 mm, or about 80-100 mm. Holes may be larger or smaller for particular tubing, and if there is more than one donor box hole 5, the holes can be of different diameters within the same cleanroom box 15. Example diameters of 80 and 100 mm are shown in FIG. 4 and FIG. 5. The location of the donor box hole 5, may be moved to different locations based on particular needs. The location of the donor box hole 5, is customer driven and it can be located anywhere on the donor box bottom 26.

When drilled, the donor box hole 5 creates open areas within the donor box bottom 26. To seal off this opening, yet still allow the passage of materials through the donor box bottom 26, the donor box hole must be sealed. Accordingly, a donor box pipe 8, is positioned within the donor box hole 5 to seal the outer circumference of the donor box hole 5. Absent the donor box pipe 8, the cleanroom box 15 would be difficult to sterilize.

The donor box pipe 8 fits within the donor box hole 5. Specifically, the donor box pipe's 8 outside diameter is the same or slightly smaller than the diameter of the donor box hole 5, thus securely fitting within the donor box hole with or without adhesive. All seams between the donor box pipe 8, the donor box hole 5, the donor box bottom 26, and the donor box bottom plate 6 will be secured with plastic welding. The donor box pipe 8 seals any openings in the donor box bottom, maintaining easy clean surfaces.

The donor box hole 5 provides access from one side of the donor box 1, through the donor box bottom 26 and into the space below, which is the pipework opening 17. This hole allows for the transfer of sterile liquids from the donor box without the need to open the removable box sides 4, or to otherwise open the cleanroom box 15.

Accordingly, the pipework opening 17 is the open space between the donor box bottom 26 and the upper pallet top 29 in FIG. 4. This space provides for the storage of pipework attached to the storage bag situated within the cleanroom box 15. The storage of the pipework provides a centralized access point for the transfer of liquids. By storing the pipework in the centralized location there is quick and easy access to the pipework for transfer of sterile materials from one container to another. Furthermore, storing the pipework away from the plastic storage bag prevents accidental puncture or rupture of the storage bag.

FIGS. 4 and 5 also show an exploded view of one embodiment of a cleanroom box 15 illustrating many of the parts of an embodiment of a cleanroom box 15. Beginning at the bottom of FIG. 5, the lower pallet base 3 is secured to the lower pallet base shelf 7 with bolts 9 and nuts 10. After securing the lower pallet shelf 7 to the lower pallet base 3, the upper pallet base 2 is then secured to the lower pallet base shelf 7. By attaching the lower pallet base 3 to the lower pallet base shelf 7, any open spaces on the lower pallet base 3 are eliminated. The donor box bottom plate 6 is then secured to the donor box 1 and the donor box 1 is thereafter secured to the upper pallet base 2. After securing these pieces together, there will be a seam between the donor box 1 and the upper pallet base 2 and between the upper and lower pallet bases 2 and 3, of approximately the thickness of the lower pallet base shelf 7 and the donor box bottom plate 6. Plastic welding will fill these seams to make easy clean surfaces, as shown in FIG. 4.

The attachment of each of the donor box bottom plate 6 and lower pallet base shelf 7 is accomplished via bolts 9 and nuts 10, or alternatively can be secured by other means known in the art, such as nails, staples, various glues and adhesives, and/or plastic welded. The parts may also be chemically fused together. However, whatever means that are used, plastic welding is used to fill and secure each seam.

FIG. 5 further shows the donor box bottom plate 6 fitting between the upper donor pallet base 22, and the donor box 1. This donor box bottom plate 6 is attached to the donor box bottom 26, and provides an easy clean surface. Finally, the donor box 1 is attached to the upper pallet base.

FIG. 4 also shows that a lower pallet base 3 is attached to the upper pallet base 2. The lower pallet base 3, when attached to the upper pallet base 2, provides an opening between the upper and lower pallet bases for a forklift or other machine to move the clean room box 15. This opening comprises the same features of the pipework opening 17, in that all seams are plastic welded and all surfaces are easy clean surfaces.

After the attachment of the lower pallet base 3 to the lower pallet base shelf 7, the combined piece is attached to the upper pallet bottom 30. The pieces are secured together by various means known in the art, including by nut and bolt, nails, staples, various glues and adhesives, and/or plastic welded. However, whatever means that are used, plastic welding is used to fill and secure each seam.

After all the articles are secured together, each seam created by the various attachments is filled by plastic welding. The purpose of filling each seam is to eliminate space or seams that would prevent sterilization of the cleanroom box. After each seam is plastic welded, the seams are cleaned, sanded, and polished as necessary. This results in smooth seams resulting in the easy clean surface. Joints that form about a 90 degree angle are also filled with plastic welding and polished in the same manner. Again, this prevents such joints from holding moisture of other undesirable materials. FIG. 3 shows an example of plastic welding at each joint.

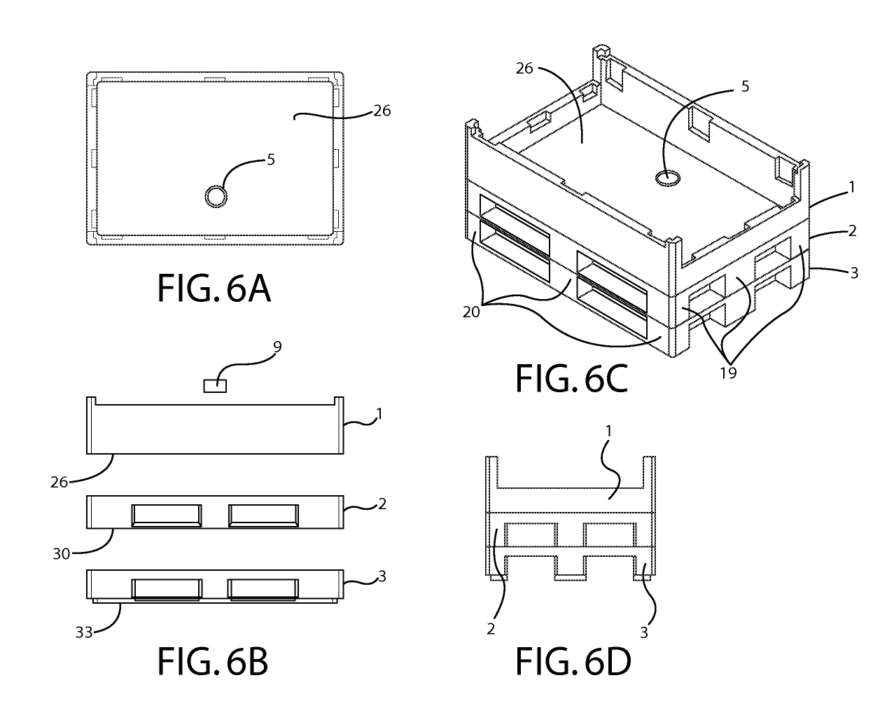

After securing all the pieces together plastic welding is required at every seam. FIGS. 4 and 6 illustrate some locations for plastic welding in the various embodiments. These locations include seams created between the donor box 1, and the upper pallet base 2 and the seams between the upper and lower pallet bases 2 and 3. These seams between two or more features are intended to be secured by plastic welding to eliminate the seams, sharp corners, and to eliminate openings. Once the plastic welding is complete at the seam, the welds are cleaned, sanded, and polished, as necessary, to create easy clean surfaces and enables quick and easy sterilization of the cleanroom box 15.

Cleaning of the donor box for entry into a clean or sterile room can be completed by various means known to one skilled in the art. Different levels of cleanliness and/or sterilization are required for different products, and will be known to one of ordinary skill in the art. The cleanroom box 15 is designed to allow for entry into the strictest cleanroom environments.

Storage of fluids in the donor box 1 typically includes the addition of a plastic bag or stainless steel insert or receptacle within the donor box 1. This plastic bag or metal receptacle actually holds the sterile liquids within the cleanroom box 15. Such a storage container fits within the confines of the donor box 1, and the removable box sides 4. The plastic bag or metal receptacle comprises tubing or pipework for the transfer of the sterile liquids. One end of the tubing is attached to the plastic bag or metal receptacle and the other end is stored in the pipework opening to allow for transfer of materials in and out of the bag or receptacle. These tubes and pipework are run through the donor box hole 5, and the tubing and pipework is stored in the pipework opening 17. Use of pipework in this manner allows for quick and easy transfer of materials from one container to another.

FIG. 6 illustrates a further embodiment of the invention where no easy clean plates are required. FIG. 6 illustrates a scenario where the donor box and the upper pallet base 2, are plastic welded together and requires no donor box bottom sheet 26, to secure the bottom of the donor box. Where a surface is already an easy clean surface, no easy clean plate is required, as the purpose of the easy clean plates is to provide easy clean surfaces. Accordingly, in the embodiment of FIG. 6, the donor box can simply be welded to an upper pallet base 2, and then the upper pallet base 2 is secured to a lower pallet base 3. The seams created by attaching these three pieces together are then plastic welded, and cleaned, sanded, and polished as necessary to create easy clean surfaces. This provides a cleanroom box that comprises a donor box 1, a pipework opening 17, and a forklift opening 18, and comprises easy clean surfaces.

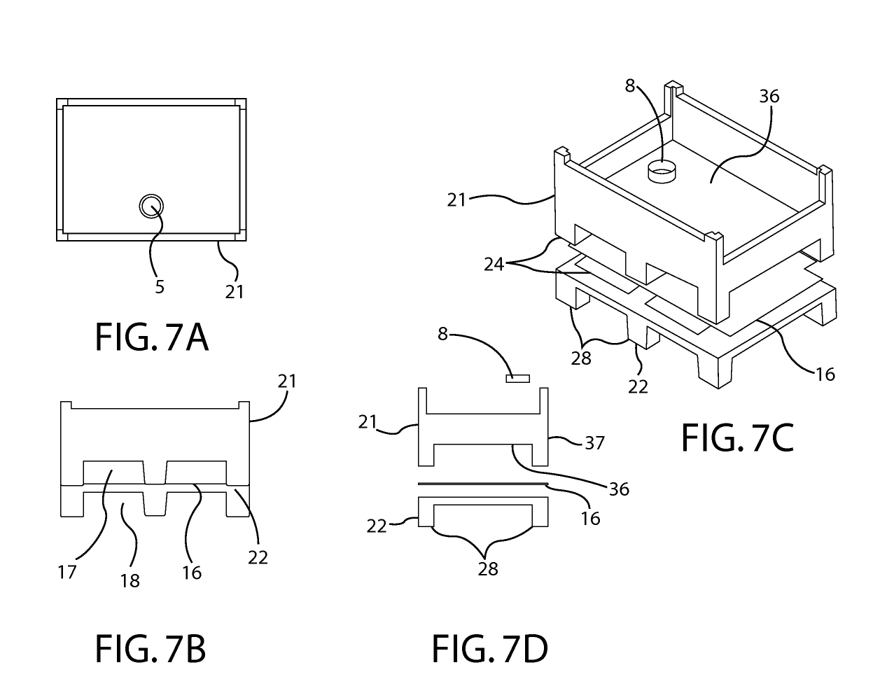

FIG. 7 shows another alternative embodiment of a cleanroom box 15 according to the invention. A footed donor box 21 allows for the use of a single table pallet base 22, and still provides both a pipework opening 17 and a forklift opening 18.

The embodiment shown in FIG. 7 still requires a pallet base shelf between the footed donor box 21, and the table donor pallet base 22. The table pallet shelf 16 is situated on top of the table pallet base 22, and can be attached via an adhesive or plastic welding as described herein. As with embodiments described in FIGS. 4 and 5, the table pallet shelf 16 performs the step of securing the top of the table pallet base 22, such that no open ribs or other support features are open to the air. Again, this is for sterility reasons. Furthermore, the table pallet shelf 16 provides lateral and horizontal support, adds rigidity to the structure, and provides a shelf for the storage of tubing and pipework.

With the embodiment of FIG. 7, should the footed donor box 21 have open support structures, as with the donor box bottom 26, a donor box bottom plate 6, would also be required. The invention herein advantageous provides that where there are areas of open support structures, or areas that could trap or harbor moisture preventing sterilization of the cleanroom box 15, an easy clean plate, such as the donor box bottom plate 6, the lower pallet base shelf 7, or the table pallet shelf 16, as identified in FIGS. 8-10, is used to seal off the open support structures and provide an easy clean surface.

Once the footed donor box 21 is attached to the table donor pallet base 22, and the table pallet shelf 16, a plastic weld is provided around all seams created by attaching each of the pieces together. The seams and joints are plastic welded and all welds are cleaned, sanded, and polished to make easy clean surfaces.

FIGS. 4-7 illustrate various embodiments of a cleanroom box 15 according to the invention. The embodiments each include a donor box 1 for storing liquids, a donor box hole 5, a pipework opening 17, a forklift opening 18, and in which all surfaces are easy clean surfaces. Because different donor boxes and pallet bases may be used, certain features are preferable used with certain donor boxes and pallet bases and not with others. One example is the easy clean plates, which may be provided for easy clean surfaces and to provide necessary stability to the product in some embodiments, but not others.

FIGS. 8-10 illustrate embodiments of easy clean plates used in various embodiments of cleanroom boxes 15 of the invention. FIG. 8 illustrates one embodiment of a table pallet shelf 16. The table pallet shelf 16 is made of a substantially inflexible material such as a plastic, plastic polymer, carbon fiber, or metal, with exterior surfaces being easy clean surfaces. The table pallet shelf 16 has about the same length and width dimensions as the pallet base to which it is to be attached, if not slightly smaller, and a thickness of from about 1 to about 10 mm. FIG. 8 shows an embodiment configured with a pallet base comprising only six supports, four on the corners and one each in the center of the two longest edges. The corner edge holes 47 and the center edge holes 48 formed with a cutout so as to fit the support legs of the footed donor box 21. Accordingly, there is a cutout wherever a leg of a pallet or donor box requires contact with another pallet. The table pallet shelf 16 seals openings in the pallet, creating easy clean surfaces, as well as providing rigidity and support for the structure.

FIG. 9 illustrates a diagram of a donor box bottom plate 6, where there are two holes in the donor box bottom plate 6 and eight cutouts. The donor box bottom plate is made of the same material as the table pallet shelf. The dimensions of the donor box bottom plate 6 are determined by the size of the donor box bottom 26. The donor box bottom plate 6 should be about the same length and width as the donor box bottom 26 and effectively seals off the donor box bottom 26 creating a smooth easy clean surface. The cutouts 13, 14, 44, and 45 allow for the attachment of a pallet around the donor box bottom plate 6. The cutouts 13, 14, 44, and 45 will require plastic welding around each cutout to secure the seams and joints.

The shelf pipe hole 14 is aligned with the donor box hole 5, either as the hole is cut after securing the donor box bottom plate 6, or the shelf pipe hole 14 is cut to match the location of the donor box hole 5. A donor box pipe 8 will be secured within the donor box hole 5 by plastic welding. Seams and edges around the donor box hole 5 will also be plastic welded as necessary. The shelf pipe hole 14 is provided to allow for the passage of piping or other materials between the donor box 1 and into the pipework opening 17.

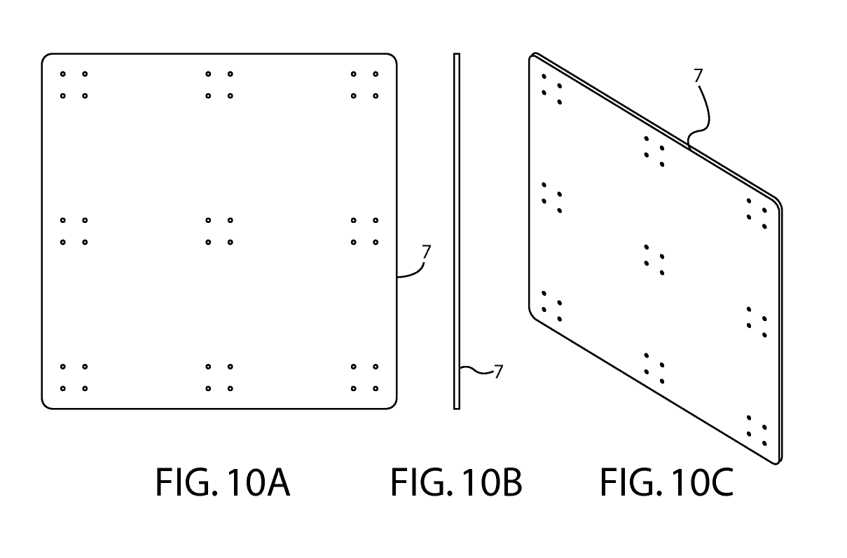

FIG. 10 shows a lower pallet base shelf 7. The lower pallet base shelf 7 is made of the same materials as the table pallet shelf 16. Like the components shown in FIGS. 8 and 9, the lower pallet base shelf 7 provides easy clean surfaces. The location of this lower pallet base shelf 7 can be clearly seen in FIG. 4, FIG. 5, and FIG. 6. The lower pallet base shelf 7 provides additional storage space and horizontal and lateral support and rigidity for the cleanroom box 15.

In certain embodiments the cleanroom box is made by first welding the donor box 1 to the donor box bottom plate 6, and sealing off any spaces or openings in the bottom of the donor box 1. Then the donor box 1, being sealed, is welded to the upper pallet base 2. The parts are welded together with 7 mm triangular weld wire for internal welds and exterior welds are done through extrusion plastic welding. After welding, the donor box hole 5 is cut into the donor box bottom 26 and the donor box bottom plate 6 at the appropriate location and diameter as needed. A donor box pipe 8 is then plastic welded into the donor box hole 5 securing all seams between the door box pipe 8, the donor box bottom plate 6, and the donor box bottom 26. Then the lower pallet base 3 is attached to the lower pallet base shelf using bolts 9 and nuts 10 or through plastic welding the pieces together. The lower pallet base 3 and lower pallet base shelf 7 are then plastic welded to the bottom of the upper pallet base through plastic welding, using 7 mm triangular weld wire for internal welds and extrusion welding of exterior welds. All seams created in the production of the cleanroom box 15 are further plastic welded to fill in any spaces created by securing various parts together. Finally, all welds are cleaned, sanded, and all external welds are flamed and/or polished.

Through this construction, all areas that could potentially harbor moisture or prevent sterilization are enclosed and the resulting surfaces are all easy clean surfaces. Further, the use of the easy clean plates shown in FIGS. 8-10, the donor bottom plate 6, the lower pallet base shelf 7, and the table pallet shelf 16 all provide additional rigidity and lateral and horizontal support for the cleanroom box 15. Not all embodiments require the use of the easy clean plates.

As illustrated in FIG. 7, another embodiment of a cleanroom box 15 are made by plastic welding a table pallet shelf 16 to a table pallet base 22, and then attaching a footed donor box 21 on top of the table pallet base 22. A donor box hole 5 is drilled in the footed donor box bottom 36, and a donor box pipe 8 is plastic welded into the hole. All seams created by securing the footed donor box 21 to the table pallet shelf 16 and the table pallet base 22 and donor box pipe 8, are plastic welded to secure the seams and fill the seams. Finally, the plastic welds are cleaned, sanded, and flamed to provide for a smooth exterior weld. The resulting product comprises a footed donor box 21, a table pallet shelf 16, and a table pallet base 22 that comprises easy clean surfaces. The configuration provides for a pipework opening 17 and a forklift opening 18.

Further embodiments may be made by securing a donor box 1 to an upper pallet base 2, and securing a lower pallet base 3 to the bottom of the upper pallet base, then drilling a donor box hole 5 into the donor box bottom 26. When necessary, a donor box pipe 8 is then secured into the donor box hole 5, to secure the openings in the donor box bottom 26. Finally, all seams and joints are plastic welded, cleaned, sanded, and flamed to provide for secure and smooth exterior seams and joints. The resulting product is a cleanroom box 15.

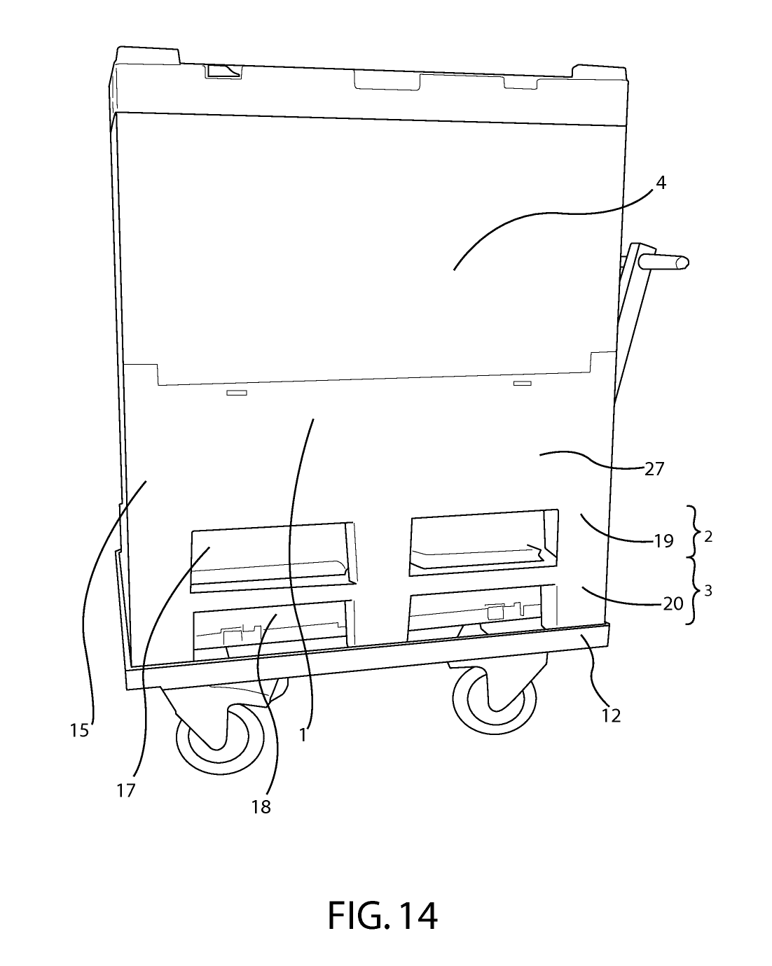

Once the cleanroom box 15 is constructed, there may be a requirement to move the cleanroom box both within a cleanroom and outside of a cleanroom. Moving the cleanroom box 15 may be achieved in a number of ways. The clean room box 15 is configured with a forklift opening 18, which allows for the quick and easy movement with a forklift or similar machine. However, the cleanroom box 15 may also be transported on a dolly 12, as shown in FIG. 14. The cleanroom box 15 is manufactured such that it is able to be loaded and carried on such a dolly 12. This is one solution to moving the cleanroom box 15 within a cleanroom environment.

Movement outside a cleanroom can include the use of a forklift. The forklift or other appropriate machine assists in the movement and transportation of the cleanroom box 15. However, once outside a cleanroom environment, the cleanroom box 15 requires re-sterilization before it can again be used for storage of sterile materials in a cleanroom environment.

The invention now being fully described, it will be apparent to one of ordinary skill in the art that many changes and modification can be made thereto without departing from the spirit or scope of the appended claims.

What is claimed is:

1. A cleanroom box comprising:
a. a donor box comprising four sides, a base, at least one leg, and at least one hole in said base; said at least one leg having a length, width, and a top and bottom, wherein said top of at least one leg is attached to said bottom of said donor box base and extending below said donor box;
b. a pallet base comprising four sides, a top and a bottom;
c. said pallet base top being secured to the bottom of said at least one leg so as to provide a first opening between the top of the pallet base and the base of the donor box;
d. a second opening situated below the pallet base bottom so as to provide an opening to accept a forklift fork; and
e. said cleanroom box being capable of being sterilized.

2. A cleanroom box of claim 1 further comprising:
a. a second pallet base comprising four sides a top and a bottom, wherein said second pallet base is secured to the bottom of the first pallet base where said second pallet base provides said second opening to accept a forklift.

3. The cleanroom box of claim 1 further comprising:
a. a pipe being secured in the hole in the base of the donor box where said pipe is plastic welded into the hole in the base of the donor box providing access between the donor box and the first opening.

4. The cleanroom box of claim 1 wherein a seam or joint created by securing said pallet base to said donor box is secured by plastic welding.

5. The cleanroom box of claim 2, wherein a seam or joint created between two or more components of the donor box are secured by plastic welding.

6. A cleanroom box for containing sterile liquids comprising:
a. a donor box comprising four sides and a base, and at least one hole in said base;
b. an upper pallet base comprising four sides, a top, and a bottom;
c. wherein each of the upper pallet base is substantially the same length and width as the donor box;
d. a first easy clean plate having a top, bottom, length and width, and being substantially the same length and width as the donor box and wherein the top of said first easy clean plate is secured to the bottom of said donor box; and
e. said cleanroom box being capable of being sterilized for use in a cleanroom.

7. The cleanroom box of claim 6 further comprising a lower pallet base, said lower pallet base comprising four sides, a top and a bottom and being substantially the same length and width as the upper pallet base;
a. a second easy clean plate of substantially the same dimensions of said first easy clean plate being secured between the upper and lower pallet bases and securing the upper and lower pallet bases together to form a single base comprising the upper and lower pallet bases and the second easy clean plate;
b. said single base being secured to said first easy clean plate thereby securing said single base to said donor box.

8. The cleanroom box of claim 6, wherein the space between the bottom of the upper pallet base and the donor box is configured to receiving and storing tubing.

9. The cleanroom box of claim 8, wherein the tubing is connected to a storage container situated in the donor box, and wherein the tubing is situated to pass through the hole in said base of the donor box.

10. The cleanroom box of claim 6 wherein the lower pallet base is suitable for use with a forklift.

11. The cleanroom box of claim 7, wherein all seams created by attaching the upper and lower pallet bases and donor box to each other are plastic welded.

12. A cleanroom box for containing sterile liquids comprising:
a. a donor box comprising four sides, a base, and at least four legs;
b. at least one pallet base of substantially the same length and width as the donor box, comprising four sides, a flat top, a base and vertical support legs below the base;
c. and an easy clean plate having a top and bottom and having substantially the same length and width as the pallet base and donor box and wherein the bottom of said easy clean plate is secured to the flat top of the at least one pallet base;
d. the donor box being secured to the pallet base by securing the bottom of the support legs to the flat top of the pallet base;
e. wherein each seam created by securing the donor box, the pallet base, and the easy clean plate together is secured by plastic welding;
f. said cleanroom box being capable of being sterilized for use in a cleanroom.

13. The cleanroom box of claim 12 further comprising a forkliftable pallet base.

14. The cleanroom box of claim 12 further comprising a hole in said donor box and a space between the donor box and a pallet base for the storage of tubing.

15. The cleanroom box of claim 12 further comprising a plastic pipe welded into the at least one hole in the base; where the plastic welding secures all seams created by adding the plastic pipe into the hole.

16. A method of manufacturing a cleanroom box comprising:
a. securing a donor box, comprising four sides, a base, and a top, to a pallet base;
b. plastic welding seams created by securing the donor box to the pallet base;
c. cutting a hole in said donor box base;
d. securing a pipe within said hole; and
e. plastic welding around the edges and seams created by securing said pipe within said hole.

17. The method of claim 16 further comprising:
a. securing a second pallet base to the bottom of the upper pallet base.

18. The method of claim 16 further comprising:
a. securing an easy clean plate between said donor box and said pallet base.

19. The method of claim 16 further comprising:
a. securing a second pallet base to said first pallet base; and
b. securing an easy clean plate between said first and second pallet bases.

20. The method of claim 16 further comprising cleaning, sanding, and polishing all exterior welds.
